(19) United States
(12) Patent Application Publication
(10) Pub. No.: US 2024/0413692 A1
(43) Pub. Date: Dec. 12, 2024

(54) MOTOR AND CONTROL SYSTEM FOR ELECTRIC VEHICLE

(71) Applicants: MAO-YING LAI, TAICHUNG CITY (TW); JIANGBAM CO., LTD., TAICHUNG CITY (TW)

(72) Inventors: MAO-YING LAI, TAICHUNG CITY (TW); JIA-HAO LAI, TAICHUNG CITY (TW)

(21) Appl. No.: 18/629,074

(22) Filed: Apr. 8, 2024

(30) Foreign Application Priority Data
Jun. 9, 2023 (TW) 112121681
Jul. 21, 2023 (TW) 112127365

(51) Int. Cl. H02K 3/28; B60L 15/20; B60L 50/60

(52) U.S. Cl. CPC H02K 3/28; B60L 15/20; B60L 50/60; H02K 2203/03

(57) ABSTRACT

A motor includes a rotor and a stator. The stator includes a stator core, and at least one coil module that is wound on the stator core. Each of the at least one coil module includes a plurality of first winding sets that are wound on the stator core. Each of the first winding sets includes a first end and a second end. For each of the at least one coil module, the first ends respectively of the first winding sets are electrically connected to each other, and the second ends respectively of the first winding sets are electrically connected to each other, such that the first winding sets are connected in parallel.

### CROSS-REFERENCE TO RELATED APPLICATION

This application claims priority to Taiwanese Invention patent application No. 112121681, filed on Jun. 9, 2023, and to Taiwanese Invention patent application No. 112127365, filed on Jul. 21, 2023, the entire disclosure of which is incorporated by reference herein.

### FIELD

The disclosure relates to a motor and a control system, and more particularly to a motor and a control system for an electric vehicle including the motor.

### BACKGROUND

A conventional motor includes a plurality of coil sets that correspond to different values of power output. A user may control the conventional motor to operate using one of the coil sets that matches a required value of power output based on demand, thereby reducing excess energy consumption and saving energy. However, when user driving demand for power output is suddenly increased while the conventional motor is still operating using a coil set that corresponds to a low-value power output, power input to the conventional motor will suddenly increase and the conventional motor may not be able to switch to another coil set that corresponds to a high-value power output in time, which may cause the coil set that corresponds to the low-value power output to burn due to excessive current.

### SUMMARY

Therefore, an object of the disclosure is to provide a motor and a control system that can alleviate at least one of the drawbacks of the prior art.

According to the disclosure, a motor includes a rotor and a stator. The stator includes a stator core, and at least one coil module that is wound on the stator core. Each of the at least one coil module includes a plurality of first winding sets that are wound on the stator core. Each of the first winding sets includes a first end and a second end. For each of the at least one coil module, the first ends respectively of the first winding sets are electrically connected to each other, and the second ends respectively of the first winding sets are electrically connected to each other, such that the first winding sets are connected in parallel.

According to the disclosure, a motor includes a rotor and a plurality of stators. The rotor extends in an axial direction. Each of the stators is sleeved on the rotor, and includes a stator core, a plurality of coil modules, a first wiring board, and a second wiring board. The coil modules are wound on the stator core. Each of the coil modules includes a plurality of first winding sets that are wound on the stator core. Each of the first winding sets includes a first end and a second end. The first wiring board and the second wiring board are disposed on the stator core and are opposite to each other along the axial direction. For each of the coil modules, the first ends respectively of the first winding sets are electrically connected to each other, and the second ends respectively of the first winding sets are electrically connected to each other, such that the first winding sets are connected in parallel. The first wiring board includes a plurality of first connection ports, the second wiring board includes a plurality of second connection ports electrically connected to the first connection ports respectively, and the coil modules are electrically connected to the first connection ports.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating a motor according to a first embodiment of the disclosure.

FIG. 2 is a schematic view illustrating an equivalent circuit of three coil modules according to the first embodiment of the disclosure.

FIG. 3 is a schematic view illustrating an equivalent circuit of the coil modules in another arrangement according to the first embodiment of the disclosure.

FIG. 4 is a plot illustrating relation between current usage and power output for various motors that include different numbers of coil groups corresponding to different values of power output.

FIG. 5 is a schematic view illustrating an equivalent circuit of three coil modules according to a second embodiment of the disclosure.

FIG. 6 is a schematic view illustrating an equivalent circuit of the coil modules in another arrangement according to the second embodiment of the disclosure.

FIG. 7 is a schematic view illustrating an equivalent circuit of three coil modules according to a third embodiment of the disclosure.

FIG. 8 is a schematic view illustrating an equivalent circuit of the coil modules in another arrangement according to the third embodiment of the disclosure.

FIG. 9 is a block diagram illustrating an energy-saving driving system using the motor in the second embodiment of the disclosure.

FIG. 10 is a block diagram illustrating a control system for an electric vehicle according to a fourth embodiment of the disclosure.

FIG. 11 is a schematic view illustrating a plurality of stators sleeved on a rotor according to the fourth embodiment of the disclosure.

FIG. 12 is a circuit diagram illustrating an AC-to-DC converter electrically connected to a plurality of second coil groups according to the fourth embodiment of the disclosure.

FIG. 13 is a schematic view illustrating arrangement of a plurality of coil modules of each stator according to the fourth embodiment of the disclosure.

FIG. 14 is a schematic view illustrating arrangement of a first wiring board according to the fourth embodiment of the disclosure.

FIG. 15 is a schematic view illustrating arrangement of a second wiring board according to the fourth embodiment of the disclosure.

FIG. 16 is a sectional view taken along line XVI-XVI in FIG. 14, illustrating the first wiring board and the second wiring board according to the fourth embodiment of the disclosure.

FIG. 17 is a schematic view illustrating another arrangement of the coil modules of each stator according to the fourth embodiment of the disclosure.

FIG. 18 is a schematic view illustrating another arrangement of the first wiring board that corresponds to the arrangement shown in FIG. 17 according to the fourth embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

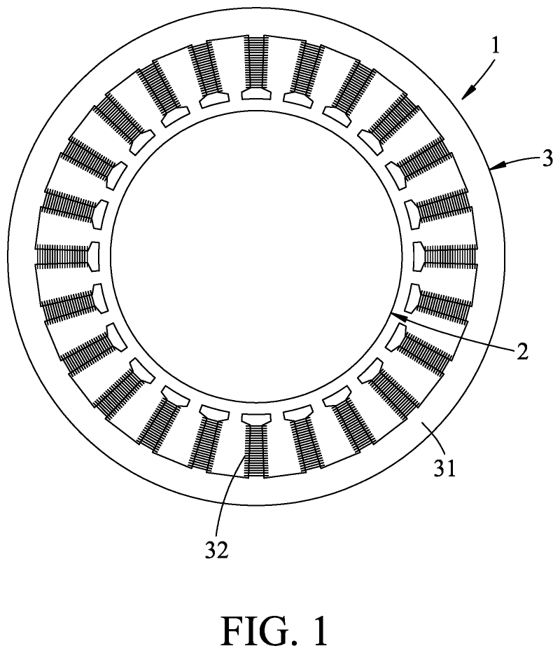

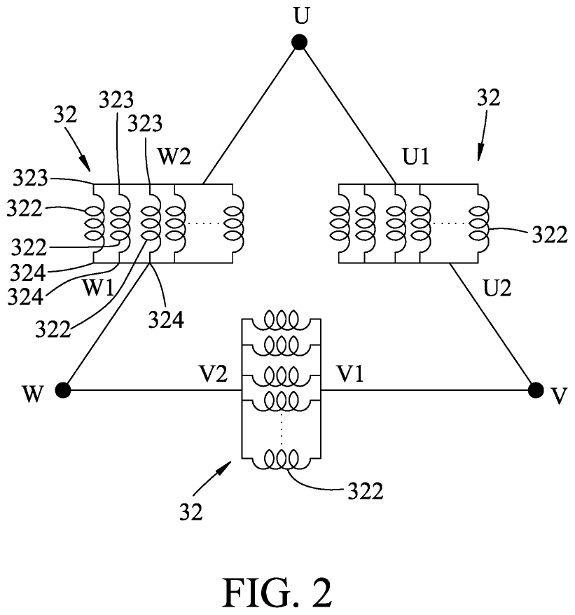

Referring to FIGS. 1 and 2, a motor 1 according to a first embodiment of the disclosure includes a rotor 2 and a stator 3. The stator 3 is sleeved on the rotor 2, where the rotor 2 is rotatable relative to the stator 3. The stator 3 includes a stator core 31 and at least one coil module 32 that is wound on the stator core 31. The stator 3 may have a single-phase architecture that includes one coil module 32, or may have a three-phase architecture that includes three coil modules 32. In the first embodiment, the stator 3 has the three-phase architecture; that is, the stator 3 includes three coil modules 32.

The coil modules 32 respectively correspond to three phases of a three-phase electric power source. Each of the coil modules 32 includes a plurality of first winding sets 322 that are wound on the stator core 31, and each of the first winding sets 322 includes a first end 323 and a second end 324 that are opposite to each other. For each of the coil modules 32, the first ends 323 respectively of the first winding sets 322 are electrically connected to each other, and the second ends 324 respectively of the first winding sets 322 are electrically connected to each other, such that the first winding sets 322 are connected in parallel.

In this embodiment, the first winding sets 322 correspond to an identical power output. Specifically, a number of turns of each of the first winding sets 322 is set to be identical. In one example, for one of the coil modules 32 that has an expected power output of 6 hp, the power output of 6 hp may be evenly attributed to the first winding sets 322. For example, the coil modules 32 having an expected power output of 6 hp may have two first winding sets 322 each corresponding to 3 HP, have three first winding sets 322 each corresponding to 2 HP, or have six first winding sets 322 each corresponding to 1 HP, etc.

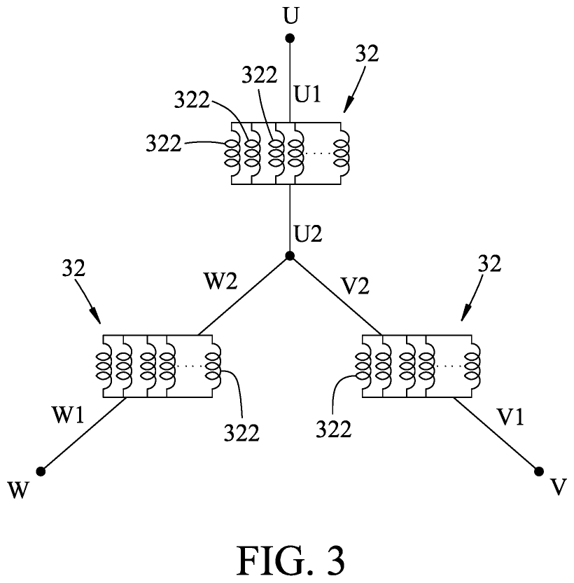

It should be noted that the coil modules 32 may be arranged in a Delta (Δ) configuration as shown in FIG. 2, or may be arranged in a Wye (Y) configuration as shown in FIG. 3. Three terminals of the Δ configuration or the Y configuration are respectively denoted as a U-terminal, a V-terminal, and a W-terminal, and respectively correspond to the U-phase, the V-phase, and the W-phase of the three-phase electric power source. For each of the first winding sets 322 of the coil module 32 that corresponds to the U-phase, two opposite ends of the parallel connection of the first winding set 322 are labelled as U1 and U2, respectively. For each of the first winding sets 322 of the coil module 32 that corresponds to the V-phase, two opposite ends of the parallel connection of the first winding set 322 are labelled as V1 and V2, respectively. For each of the first winding sets 322 of the coil module 32 that corresponds to the W-phase, two opposite ends of the parallel connection of the first winding set 322 are labelled as W1 and W2, respectively.

Since one having ordinary skill in the art may infer the arrangement details of the coil modules 32 based on the description above, it will not be described in further detail for the sake of brevity.

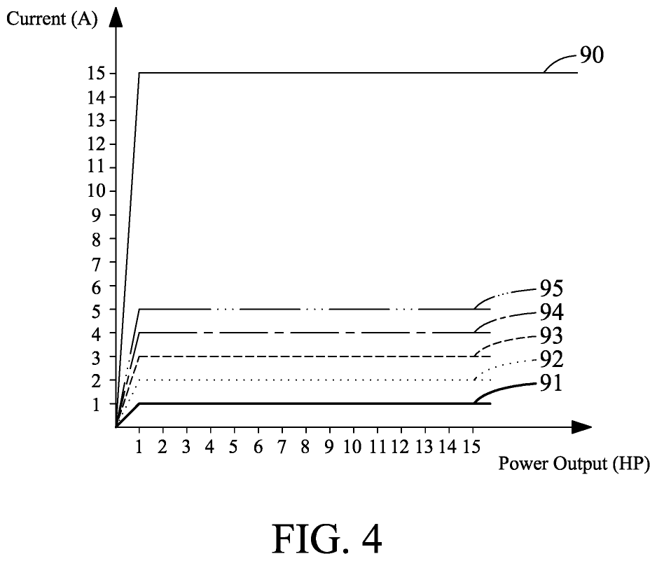

Referring to FIGS. 1, 2, and 4, each of the coil modules 32 is exemplified to have a power output of 15 hp, and curves 91 to 95 in FIG. 4 correspond to the coil modules 32 while a curve 90 corresponds to a conventional motor. For simplicity, only one of the coil modules 32 will be described in detail in the following.

The curve 91 illustrates a current usage by the coil module 32 that includes fifteen first winding sets 322 each corresponding to a power output of 1 hp; the curve 92 illustrates the current usage by the coil module 32 that includes seven first winding sets 322 each corresponding to a power output of 2 hp and one first winding set 322 corresponding to a power output of 1 hp; the curve 93 illustrates the current usage by the coil module 32 that includes five first winding sets 322 each corresponding to a power output of 3 hp; the curve 94 illustrates the current usage by the coil module 32 that includes three first winding sets 322 each corresponding to a power output of 4 hp and one first winding set 322 corresponding to a power output of 3 hp; the curve 95 illustrates the current usage by the coil module 32 that includes three first winding sets 322 each corresponding to a power output of 5 hp.

It should be noted that for each of the curves 91 to 95, the current usage that corresponds thereto is limited by the first winding set 322 with the highest value of power output in the coil module 32. The curve 90 illustrates the current usage by the conventional motor that has a power output of 15 hp.

TABLE 1

| | Current usage | Current | |
|---|---|---|---|
| | by motor of | usage by | |
| Power output | the first | conventional | Energy saving |
| of motor | embodiment | motor | ratio |

| | | | | |
|---|---|---|---|---|
| 15 | hp | 1 | 15 | 14 |
| 14 | hp | 1 | 14 | 13 |
| 13 | hp | 1 | 13 | 12 |
| 12 | hp | 1 | 12 | 11 |
| 11 | hp | 1 | 11 | 10 |
| 10 | hp | 1 | 10 | 9 |
| 9 | hp | 1 | 9 | 8 |
| 8 | hp | 1 | 8 | 7 |
| 7 | hp | 1 | 7 | 6 |
| 6 | hp | 1 | 6 | 5 |
| 5 | hp | 1 | 5 | 4 |
| 4 | hp | 1 | 4 | 3 |
| 3 | hp | 1 | 3 | 2 |
| 2 | hp | 1 | 2 | 1 |
| 1 | hp | 1 | 1 | 0 |

Further referring to Table 1, compared to a conventional motor, which uses 1 to 15 units of current to provide a power output of 1 hp to 15 hp respectively, the coil module 32 that corresponds to the curve 91 is capable of providing a power output of 1 hp to 15 hp while consuming only 1 unit of current. In this embodiment, 1 unit of current is exemplified to be 1 A.

An energy saving ratio in Table 1 is calculated as (current usage by conventional motor-current usage by the motor of the first embodiment)/(current usage by the motor of the first embodiment). In one example, compare the coil module 32 that corresponds to the curve 91 and that has a power output of 15 hp to the conventional motor that has a power output of 15 hp, the energy saving ratio is equal to (15−1)/1=14. In another example, compare the coil module 32 that corresponds to the curve 91 and that has a power output of 14 hp to the conventional motor that has power output of 14 hp, the energy saving ratio is equal to (14−1)/1=13. It can be clearly seen that the current usage by the motor 1 of the first embodiment of the disclosure is significantly reduced compared to the conventional motor.

In the first embodiment, for each of the coil modules 32, the first winding sets 322 are connected in parallel such that the first winding sets 322 cooperates to output the horsepower corresponding to the coil module 32, which significantly reduces the current usage as shown in Table 1.

Furthermore, since the first winding sets 322 are connected in parallel, the first winding sets 322 not only stably provide driving power for the motor 1, but also act as multiple dispersion paths for distributing the current received by the motor 1, so as to prevent the first winding sets 322 from burning when the current provided (i.e., user driving demand) is suddenly increased.

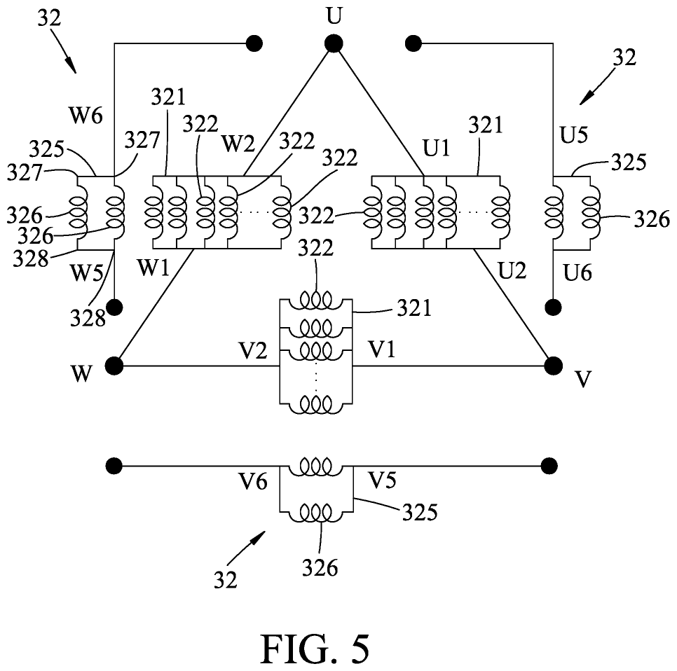

Referring to FIGS. 1 and 5, the motor 1 according to a second embodiment of the disclosure is similar to the first embodiment. Differences between the two embodiments will be described in the following.

In the second embodiment, each of the coil modules 32 further includes a first coil group 321 and a second coil group 325. The first coil group 321 includes the first winding sets 322. The second coil group 325 includes a plurality of second winding sets 326 that are wound on the stator core 31. Each of the second winding sets 326 includes a third end 327 and a fourth end 328. For each of the coil modules 32, the third ends 327 respectively of the second winding sets 326 are electrically connected to each other, and the fourth end 328 respectively of the second winding sets 326 are electrically connected to each other, such that the second winding sets 326 are connected in parallel. The second winding sets 326 correspond to an identical power output.

Furthermore, for each of the coil modules 32, a number of the first winding sets 322 of the first coil group 321 is greater than a number of the second winding sets 326 of the second coil group 325; a power output corresponding to the first winding sets 322 is smaller than a power output corresponding to the second winding sets 326; and a number of turns of each of the first winding sets 322 is smaller than a number of turns of each of the second winding sets 326.

In practice, the first coil group 321 and the second coil group 325 may be connected in parallel and used for driving the motor 1 together. Alternatively, the second coil group 325 may also be used for generating electricity during operation of the first coil group 321 due to electromagnetic induction.

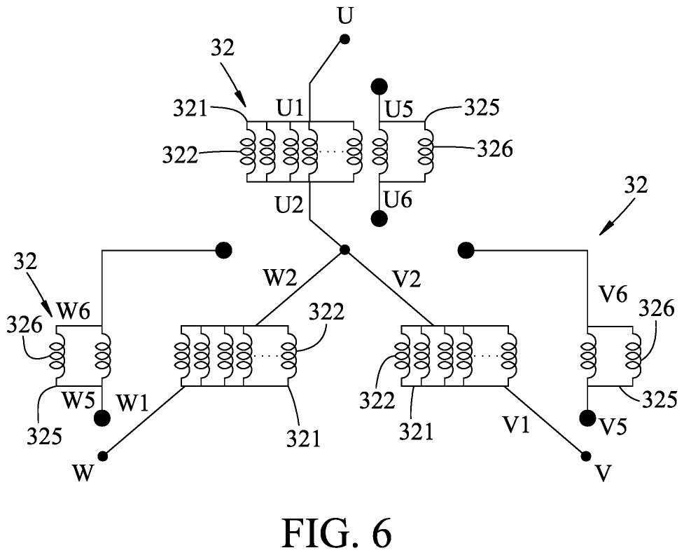

It should be noted that the coil modules 32 may be arranged in the Δ configuration as shown in FIG. 5, or may be arranged in the Y configuration as shown in FIG. 6. Details of the arrangement of the first winding sets 322 are similar to the first embodiment and will not be described in further detail. Furthermore, for each of the second winding sets 326 of the coil module 32 that corresponds to the U-phase, two ends of the second winding sets 326 are labelled as U5 and U6 respectively. For each of the second winding sets 326 of the coil module 32 that corresponds to the V-phase, two ends of the second winding sets 326 are labelled as V5 and V6 respectively. For each of the second winding sets 326 of the coil module 32 that corresponds to the W-phase, two ends of the second winding sets 326 are labelled as W5 and W6 respectively.

The following Table 2 shows a relationship among a power output of each of the first winding sets 322, voltage across each of the first winding sets 322, a power output of each of the second winding sets 326, and voltage across each of the second winding sets 326.

In one example, in the first row of Table 2, when each of the first winding sets 322 corresponds to a power output of 1 hp, when the voltage across each of the first winding sets 322 (which is the same as an input voltage from the three-phase electric power source) is 220V, and when each of the second winding sets 326 corresponds to a power output of 1 hp, the voltage across each of the second winding sets 326 (i.e., induced voltage) will be 220V.

Since one having ordinary skill in the art may be able to infer different induced voltages for each of the second winding sets 326 by adjusting the power output of each of the second winding sets 326 (i.e., by adjusting the number of turns) based on Table 2, it will not be described in further detail for the sake of brevity.

TABLE 2

| | | Voltage across | | | Voltage across |
|---|---|---|---|---|---|
| Power output | | first winding | Power output | | second winding |
| of first | | set (input | of second | | set (induced |
| winding set | | voltage) | winding set | | voltage) |
| 1 | hp | 220 V | 1 | hp | 220 V |
| 1 | hp | 220 V | 2 | hp | 440 V |
| 1 | hp | 220 V | 3 | hp | 660 V |
| 1 | hp | 220 V | 4 | hp | 880 V |
| 2 | hp | 220 V | 1 | hp | 110 V |
| 2 | hp | 220 V | 2 | hp | 220 V |
| 2 | hp | 220 V | 3 | hp | 330 V |
| 2 | hp | 220 V | 4 | hp | 440 V |
| 2 | hp | 220 V | 5 | hp | 550 V |
| 2 | hp | 220 V | 6 | hp | 660 V |
| 2 | hp | 220 V | 7 | hp | 770 V |
| 3 | hp | 220 V | 3 | hp | 220 V |
| 3 | hp | 220 V | 5 | hp | 366 V |
| 3 | hp | 220 V | 6 | hp | 440 V |
| 3 | hp | 220 V | 9 | hp | 660 V |
| 5 | hp | 220 V | 5 | hp | 220 V |
| 5 | hp | 220 V | 8 | hp | 352 V |
| 5 | hp | 220 V | 10 | hp | 440 V |
| 10 | hp | 220 V | 10 | hp | 220 V |
| 10 | hp | 220 V | 15 | hp | 330 V |
| 10 | hp | 220 V | 20 | hp | 440 V |

As such, the second embodiment achieves the same function as the first embodiment, and is further capable of generating electricity during operation of the first coil group 321 using the second coil group 325, which allows the motor 1 to reuse energy generated by the second coil group 325 and thus further reduces current usage.

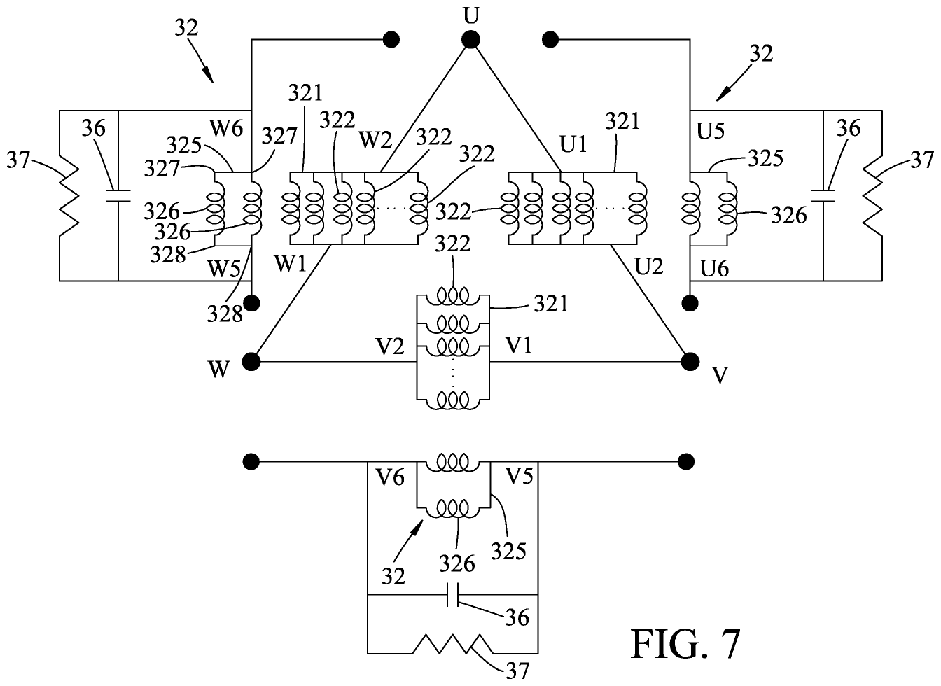

Referring to FIGS. 1 and 7, the motor 1 according to a third embodiment of the disclosure is similar to the second embodiment. Differences between the two embodiments will be described in the following.

In the third embodiment, each of the coil modules 32 further includes a capacitor 36 and a resistor 37 that are connected in parallel with the second winding sets 326. That is to say, the capacitor 36, the resistor 37 and the second winding sets 326 are connected in parallel.

When the second winding sets 326 detect that the first winding sets 322 are connected to electric power (i.e., receiving electric power from the three-phase electric power source), the second winding sets 326 (i.e., the second coil group 325) generate electricity, which causes the capacitor 36 to be charged. The capacitor 36 that is charged will generate an electric field that influences a magnetic field of the second winding sets 326 such that an efficiency of the second winding sets 326 generating electricity is increased. As such, current usage from external power source (i.e., the three-phase electric power source) by the motor 1 may be reduced since more power is generated by the second winding sets 326 to be used by the motor 1.

On the other hand, when the first winding sets 322 are not connected to the electric power (i.e., when the first winding sets 322 are not operating), the charge remaining in the capacitor 36 may be released through the resistor 37 so as to prevent the motor 1 from being damaged by the floating voltage caused by the remaining charge. It should be noted that, in the three-phase architecture, the number of the resistors 37 may be reduced to two instead of three, while still achieving the same function.

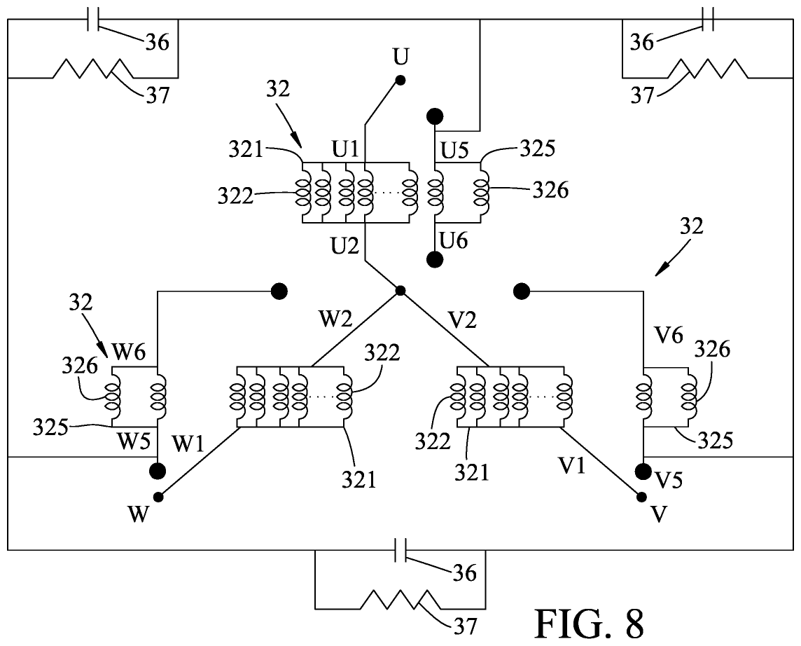

Further referring to FIG. 8, in an example that the coil modules 32 are arranged in the Y configuration, each coil module 32 has a parallel connection of the capacitor 36 and the resistor 37, and the three parallel connections of the capacitors 36 and the resistors 37 respectively of the coil modules 32 are connected respectively between the U5-end and the W5-end, W5-end and the V5-end, and V5-end and the U5-end of the second winding sets 326. Similarly, the number of the resistors 37 may be reduced to two instead of three, while still achieving the same function.

As such, the third embodiment achieves the same function as the second embodiment, and further provides the capacitors 36 and the resistors 37 to further reduce current usage by the motor 1.

Referring to FIGS. 1, 5, and 9, the motor 1 according to the second embodiment is applied to an energy saving driving system.

The energy saving driving system includes the motor 1 in the second embodiment, a power circuit 411, a transmission device 412, a generator set 413, a rectifier 414 (e.g., an AC/DC converter for converting alternating current (AC) to direct current (DC)), a microcontroller unit (MCU) 415, an input/output (I/O) interface 416, a human-machine interface (HMI) 417, and a three-phase rectifier diode circuit 418, a battery 419, a three-phase grid-connected inverter 420, a plurality of power capacitors 421, a plurality of fuseless switches 422, a plurality of voltmeters 423, a plurality of ammeters 424, and a plurality of power meters 425.

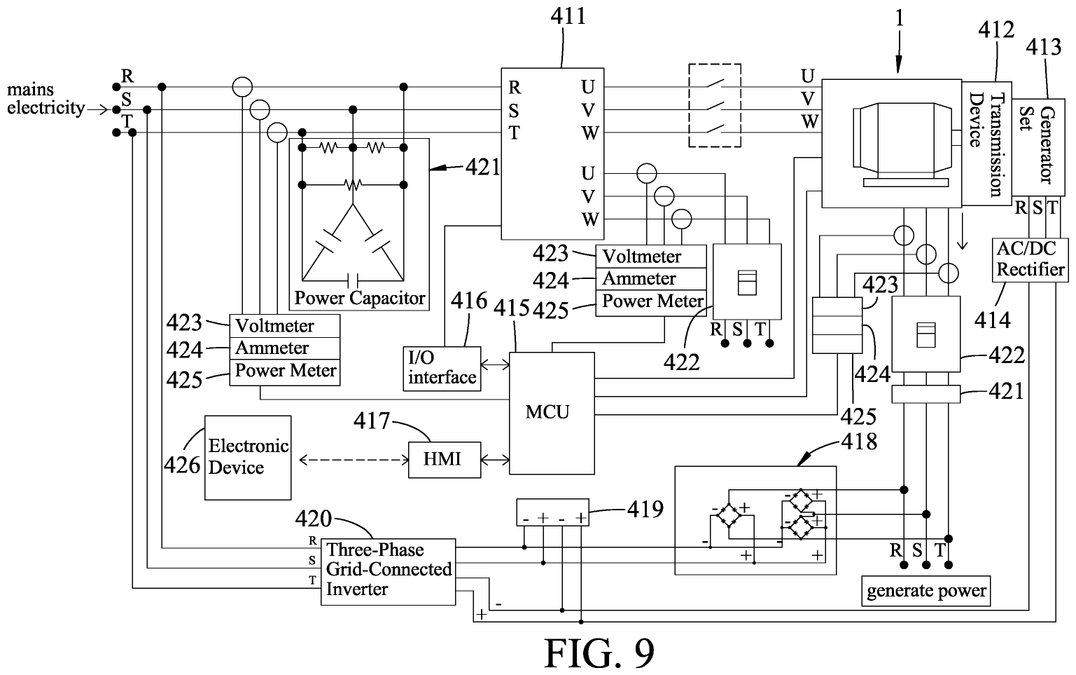

As shown in the upper left corner of FIG. 9, main electricity (e.g., a three-phase electric power source indicated by R, S, and T) is provided to the power circuit 411 after being stabilized by one of the power capacitors 421. The power circuit 411 may be an amplifier or an inverter that is capable of changing a current or a voltage frequency of the mains electricity, where the three-phase electric power outputted by the power circuit 411 is represented by U, V, and W.

The power circuit 411 is controlled by the MCU 415 through the I/O interface 416, and outputs the three-phase electric power to the motor 1 so as to drive the first coil group 321 of the motor 1 to operate. In some embodiments, the power circuit 411 is capable of further providing another set of three-phase electric power (as shown in FIG. 9, the U, V, W at the lower part of the power circuit 411).

The first coil group 321 of the motor 1 operates based on the three-phase electric power outputted by the power circuit 411 (hereinafter referred to as “electric power”). When there is excess electric power in the energy saving driving system, and when the second coil group 325 detects that the first coil group 321 is operating, the second coil group 325 may output induced voltage to one of the fuseless switches 422 and one of the power capacitors 421 so as to generate electricity. The induced voltage may further be converted to DC by the three-phase rectifier diode circuit 418 and be stored in the battery 419. The induced voltage may further be converted to be compatible with the mains electricity (i.e., the three-phase electric power source) through the three-phase grid-connected inverter 420, and be outputted back to the main power grid. That is to say, the three-phase electric power generated by the three-phase grid-connected inverter 420 may be reused by the energy saving driving system or may be sold to the provider of the main power grid.

Furthermore, when there is excess electric power in the energy saving driving system, the motor 1 may drive the generator set 413 through the transmission device 412 that may include a flywheel (not shown) to generate electricity, which may be converted to DC by the rectifier 414 and be stored in the battery 419, or may be further converted to be compatible with the mains electricity by the three-phase grid-connected inverter 420 and be outputted back to the main power grid as mentioned previously.

When the motor 1 is operating, a temperature sensor (not shown) or a tachometer (not shown) may be used to detect and send a temperature or a rotational speed of the motor 1 to the MCU 415.

The voltmeters 423, the ammeters 424, and the power meters 425 are used to respectively detect a voltage, a current, and a power of the induced voltage outputted by the motor 1, the mains electricity outputted to the power circuit 411, and the another set of three-phase electric power outputted by the power circuit 411, and send information thus detected to the MCU 415.

After the MCU 415 receives data including the temperature or the rotational speed from the temperature sensor or the tachometer, or the voltage, the current, and the power from the voltmeters 423, the ammeters 424, and the power meters 425, the MCU 415 may analyze the data, or may transfer the data to an electronic device 426 through the HMI 417 using Wi-Fi. The electronic device 426 may be a mobile phone, a tablet, a laptop, or a personal computer.

Since one having ordinary skill in the art may infer details of the architecture of the energy saving driving system based on the description above, it will not be described in further detail for the sake of brevity.

The energy saving driving system of the disclosure is capable of driving the motor 1 with lower current usage due to the structural setup of the motor 1 as describe in the second embodiment, and the motor 1 is further capable of, when there is excess electric power in the energy saving driving system, generating electricity using the second coil group 325, and reusing the electricity, storing the electricity in the battery 419, or outputting the electricity to the main power grid.

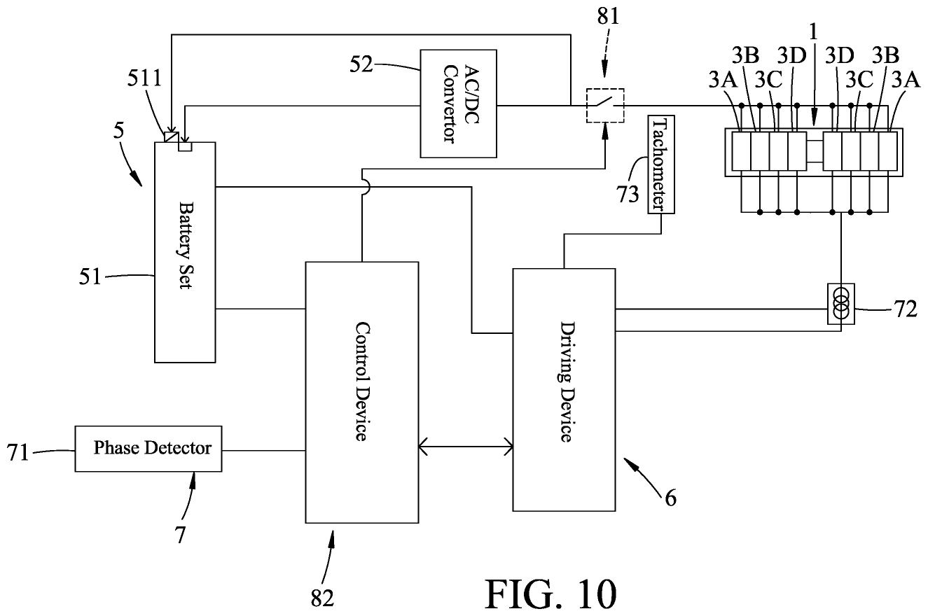

Referring to FIG. 10, a control system for an electric vehicle according to a fourth embodiment of the disclosure is provided. The control system includes a power supply device 5, a driving device 6, the motor 1 of the disclosure, a detection device 7, a switch 81, and a control device 82. In this embodiment, the motor 1 includes the rotor 2 and a plurality of the stators 3

The power supply device 5 is configured to provide electric power, and includes a battery set 51, and may optionally include an AC/DC converter 52 that is electrically connected to the battery set 51. It should be noted that since the battery set 51 may itself include an AC/DC conversion circuit 511 depending on a manufacturer of the battery set 51, the AC/DC converter 52 may be omitted in such a case.

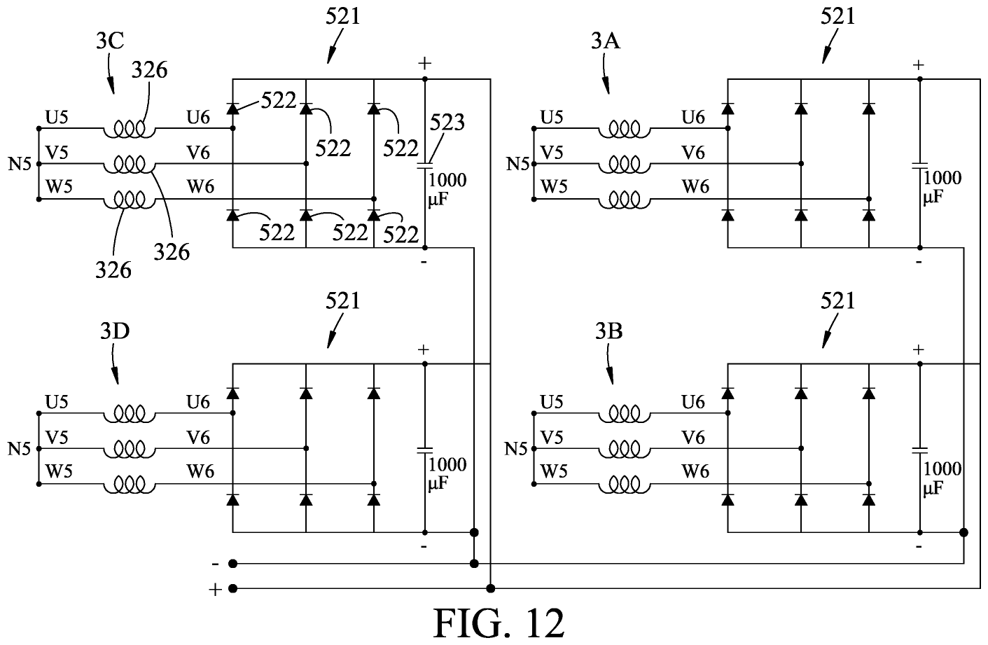

The AC/DC converter 52 may be implemented using, for example, a plurality of three-phase bridge rectifier circuits 521 as shown in FIG. 12. Each of the three-phase bridge rectifier circuits 521 has six diodes 522, where every two of the diodes 522 are connected to each other in a series connection, and the three series connections of the diodes 522 are connected to each other in parallel. Each of the three-phase bridge rectifier circuits 521 further includes a capacitor 523 that is connected in parallel to the three series connections of the diodes 522.

The driving device 6 is electrically connected to the power supply device 5. The stators 3 are electrically connected to the power supply device 5 and the driving device 6.

The detection device 7 is electrically connected to the power supply device 5 and is configured to make detection on either a terrain where the electric vehicle, which is provided with the motor 1, is located or an operation of the motor 1, and to output a detection signal related to a result of the detection (e.g., an inclination of the terrain, a current of the motor 1, or a rotational speed of the motor 1).

The detection device includes a phase detector 71, an ammeter 72 and a tachometer 73. The phase detector 71 is configured to detect the terrain where the electric vehicle is located; for example, if the electric vehicle is on a road, the phase detector 71 may detect a gradient of the road or a left-right tilt of the road as the inclination of the terrain. The phase detector 71 may be implemented with a gyroscope, an accelerometer, or an inclinometer, or may be connected to satellites, networks, or databases to obtain information on the terrain. The ammeter 72 may be implemented with a current transformer or any related electric circuits. The tachometer 73 is well known to one having ordinary skill in the art and will not be described in further detail.

The control device 82 is electrically connected to the power supply device 5, the driving device 6 and the detection device 7, and is configured to output a control signal to the driving device 6 based on the detection signal received from the detection device 7. The control device 82 may be implemented as an on-board computer of the electric vehicle, and may include a battery management system (BMS) and a motor driving circuit. Since one having ordinary skill in the art may infer the details of the control device 82, it will not be described in further detail.

The switch 81 is electrically connected to the power supply device 5, the stators 3 and the control device 82, and is configured to be controlled by the control device 82 to switch between a connecting state where the switch 81 electrically connects the stators 3 to the power supply device 5, and a disconnecting state where the switch 81 disconnects the stators 3 from the power supply device 5. That is to say, based on user needs, the stators 3 may be switched between providing generated power or not providing generated power to the power supply device 5, details of which will be described later.

The driving device 6 is configured to output a driving signal to the motor 1 based on the control signal received from the control device 82, and the motor 1 is configured to operate based on the driving signal received from the driving device 6. Since the driving device 6 is well known to one having ordinary skill in the art, it will not be described in further detail for the sake of brevity.

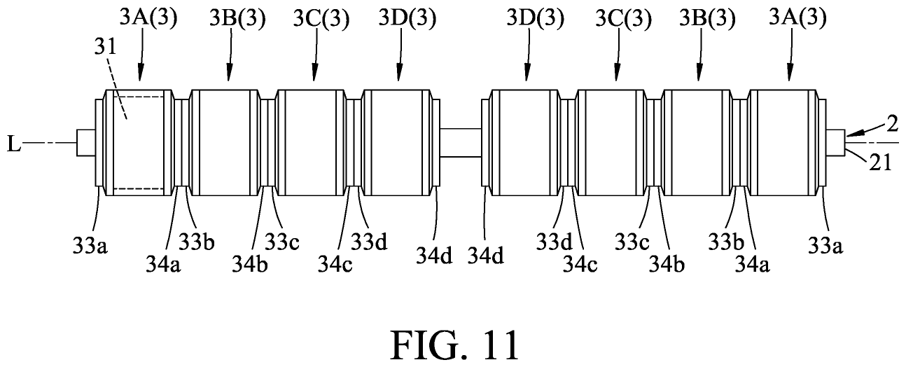

Further referring to FIGS. 11 and 12, the rotor 2 extends in an axial direction (L), and includes a rotating shaft 21. Each of the stators 3 is sleeved on the rotor 2. In this embodiment, the motor 1 includes eight stators 3, which are divided into two groups that are disposed on a left part and a right part of the rotor 2 respectively (as shown in FIG. 11). Four of the stators 3 included in each group are respectively denoted as 3A, 3B, 3C, and 3D. It should be noted that a number of the stators 3 is not limited to the abovementioned example, and may be either an odd number or an even number.

In this embodiment, the two groups of the stators 3 are disposed symmetrically along the axial direction (L), and two of the stators 3 that are symmetrical in position (e.g., the two stators 3A in FIG. 11) operate in the same manner. An annular weight such as a flywheel (not shown) may be disposed on the rotator 2 between the two groups of the stators 3 to increase rotary inertia of the rotator 2 and thus reducing power consumption by the motor 1. In a case where the number of the stators 3 is an odd number, such as seven, the stator 3D may be disposed at the center, with two groups of the stators 3 each including the stator 3A, the stator 3B, and the stator 3C being respectively disposed on the left and the right of the stator 3D.

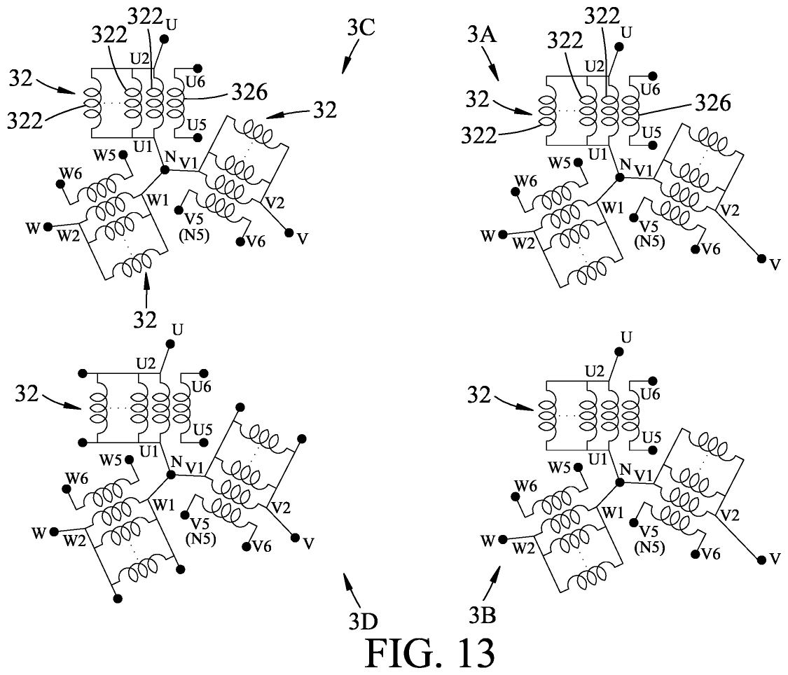

As shown in FIG. 13, in this embodiment, each of the stators 3 is a three-phase stator, and is arranged in the Y configuration.

Referring to FIGS. 11, 13, and 14, for each of the stators 3, the stator 3 includes the stator core 31, a plurality of the coil modules 32 that are wound on the stator core 31, a first wiring board 33 and a second wiring board 34 that are disposed on the stator core 31 and that are opposite to each other along the axial direction (L). For clarity, the stators 3A, 3B, 3C, 3D respectively include the first wiring boards 33a, 33b, 33c, 33d and the second wiring boards 34a, 34b, 34c, 34d.

Referring to FIGS. 10, 12, and 13, each of the coil modules 32 includes a plurality of the first winding sets 322 and one second winding set 326. For each of the coil modules 32, the first winding sets 322 are electrically connected to the power supply device 5 through the driving device 6, so as to operate based on the electric power received from the power supply device 5. For each of the coil modules 32, the second winding set 326 may be electrically connected to the battery set 51 under control of the switch 81, such that the second winding set 326 may generate electricity when the first winding sets 322 are operating, and may provide the generated electricity to the battery set 51.

In a case where the power supply device 5 further includes the AC/DC converter 52, for each of the stators 3 that is arranged in the Y configuration, the U6-end, the V6-end, and the W6-end are respectively connected between the three series connections of the diodes 522 (as shown in FIG. 12). When the stators 3 are electrically connected to the power supply device 5, the stators 3 may choose to convert the electricity outputted therefrom from AC to DC through the AC/DC converter 52, and then input the electricity thus converted to the battery set 51, or may choose to output the electricity directly to the battery set 51, and the AC/DC conversion circuit 511 of the battery set 51 converts the electricity from AC to DC.

In this embodiment, the switch 81 is configured to connect/disconnect the stators 3 to/from the power supply device 5 altogether. In some embodiments, the switch 81 may connect/disconnect any one, two, or three of the stators 3 to/from the power supply device 5, but the disclosure is not limited to such.

The control device 82 may control the switch 81 to switch between the connecting state and the disconnecting state. When the detection signal indicates that the inclination of the terrain is greater than 10 degrees (e.g., the gradient or the left-right tilt is greater than 10 degrees), the control device 82 controls the switch 81 to switch to the disconnecting state. As such, the stators 3 would be disconnected from the power supply device 5, and load on the first winding sets 322 of each of the stators 3 may be reduced. When the detection signal indicates that the inclination of the terrain is smaller than 10 degrees, or that the rotational speed of the motor 1 corresponds to a speed of the electric vehicle being greater than 50 km/h, the control device 82 controls the switch 81 to switch to the connecting state. As such, the second winding sets 326 respectively of the stators 3 may be used to generate power and to provide power to the power supply device 5.

Referring to FIGS. 11, 13, 14, and 15, each of the first wiring boards 33 has a ring shape, and includes a plurality of first wiring areas 331 and a plurality of first connection ports 332. The first connection ports 332 are arranged in a plurality of first port groups that are disposed respectively in the first wiring areas 331. For each of the stators 3, the coil modules 32 are electrically connected to the first connection ports 332.

In this embodiment, each of the first wiring boards 33 includes four first wiring areas 331a, 331b, 331c, 331d, and the first connection ports 332 are arranged in four first port groups to be respectively disposed in the four first wiring areas 331a, 331b, 331c, 331d. For each of the stators 3, the coil modules 32 are electrically connected to the first connection ports 332 of one of the first port groups that is disposed in one of the first wiring areas 331.

In one example, for every adjacent two of the stators 3, in one of the adjacent two of the stators 3 (e.g., the stator 3A), the coil modules 32 are electrically connected to the first connection ports 332 of one of the first port groups that is disposed in a first one of the first wiring areas 331 (e.g., the first wiring area 331a); in another one of the adjacent two of the stators 3 (e.g., the stator 3B), the coil modules 32 are electrically connected to the first connection ports 332 of one of the first port groups that is disposed in a second one of the first wiring areas 331 (e.g., the first wiring area 331b). It should be noted that the first one of the first wiring areas 331 is preferably misaligned with the second one of the first wiring areas 331 along the axial direction (L).

For each of the stators 3, each of the coil modules 32 has either a group of U, V, W terminals or a group of U, V, W, N terminals electrically connected to the first connection ports 332 that are disposed in the one of the first wiring areas 331.

Three terminals and a common point of the first winding sets 322 are respectively denoted as the U-terminal, the V-terminal, the W-terminal, and an N-terminal. Details of the arrangement of the first winding sets 322 and the second winding set 326 are similar to the second embodiment and will not be described in further detail. It should be noted that three terminals of the second winding set 326 are equal to the U6-end, the V6-end, and the W6-end, and a common point of the second winding set 326 is denoted as N5.

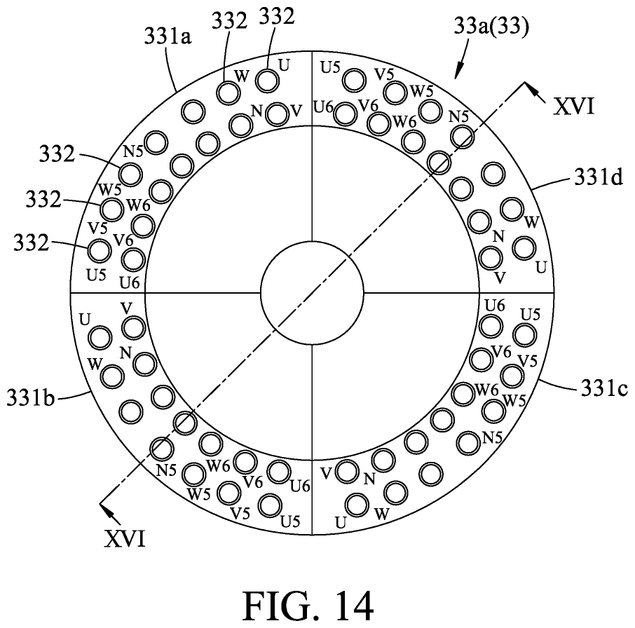

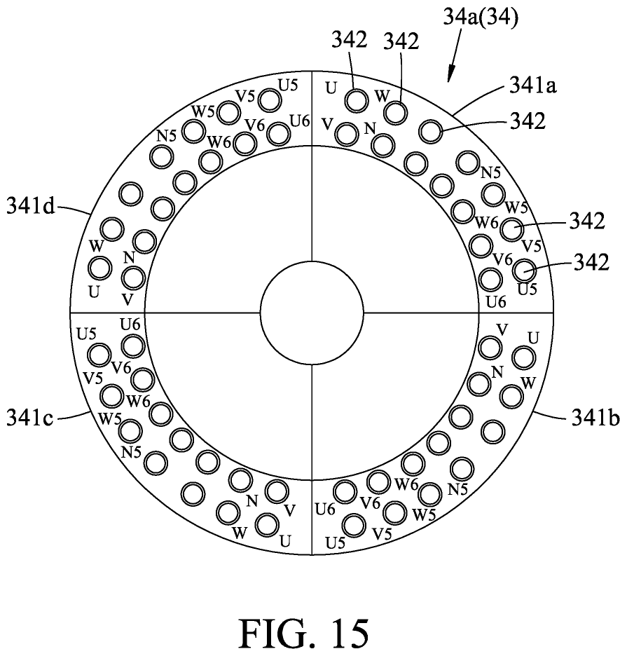

For simplicity, since each of the first wiring boards 33 are identical and each of the second wiring boards 34 are identical, only one of the first wiring boards 33a and one of the second wiring boards 34a will be described in detail. FIG. 14 illustrates an arrangement of the first wiring board 33a when viewing from the left in FIG. 11. FIG. 15 illustrates an arrangement of the second wiring board 34a when viewing from the right in FIG. 11.

In this embodiment, since the stators 3 are arranged in the Y configuration, take the stator 3A and the first wiring area 331a as an example, the first winding sets 322 are connected to four of the first connection ports 332 that are disposed in the first wiring area 331a through the U-terminal, the V-terminal, the W-terminal, and the N-terminal; the second winding sets 326 are connected to seven of the first connection ports 332 that are disposed in the first wiring area 331a through the U5-end, the U6-end, the V5-end, the V6-end, the W5-end, the W6-end, and the N5-end. The other first wiring areas 331b, 331c, 331d respectively of the first wiring boards 33b, 33c, 33d are connected respectively to the coil modules 32 of the other stators 3B, 3C, 3D in a similar manner, and will not be described in further detail.

Each of the second wiring boards 34 has a ring shape, and includes a plurality of second wiring areas 341 that correspond respectively to the first wiring areas 331 in position. The second connection ports 342 are arranged in a plurality of second port groups that are disposed respectively in the second wiring areas 341, and the second connection ports 342 of one of the second port groups correspond respectively to the first connection ports 332 of a corresponding one of the first port groups in position.

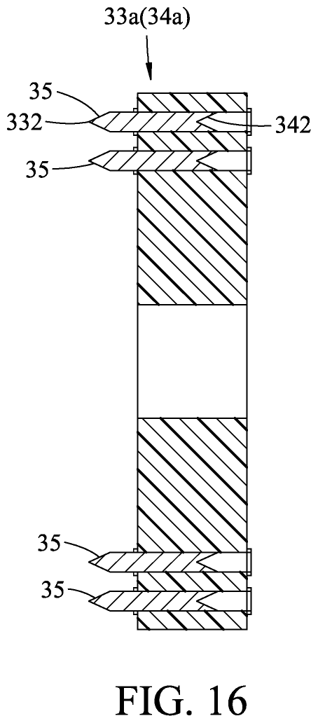

Referring to FIGS. 14 to 16, in this embodiment, the second wiring areas 341 corresponding respectively to the first wiring areas 331 in position is referred to as mirror correspondence. Each of the stators 3 includes a plurality of conductive components 35 disposed on the first wiring board 33 and the second wiring board 34. For each of the stators 3, a set of the conductive components 35 that are disposed on the first wiring board 33 protrudes from the first wiring board 33 to form the first connection ports 332, and another set of the conducting components 35 that are disposed on the second wiring board 34 sinks into the second wiring board 34 to form the second connection ports 342. The conducting components 35 are made of a conductive material. In this embodiment, since a structure of the set of the conductive components 35 and the another set of the conducting components 35 are identical, only one of the conductive components 35 (as shown in FIG. 16) will be described in detail in the following.

Referring to FIGS. 11 and 16, for every adjacent two of the stators 3, when one of the first wiring boards 33 (e.g., the first wiring board 33b) of one of the adjacent two of the stators 3 (e.g., the stator 3B) is engaged with one of the second wiring boards 34 (e.g., the second wiring board 34a) of another one of the adjacent two of the stators 3 (e.g., the stator 3A), such that the first connection ports 332 of one of the first port groups that is disposed in one of the first wiring areas 331 (e.g., the first wiring area 331b) are connected to the corresponding second connection ports 342 (e.g., the second connection ports 342 of one of the second port groups that is disposed in the second wiring area 341b), the adjacent two of the stators 3 are considered to be electrically connected with each other. However, the disclosure is not limited to the abovementioned example.

Once the stators 3A, 3B, 3C, 3D are electrically connected to each other as described above, the first connection ports 332 corresponding in position on the first wiring boards 33a, 33b, 33c, 33d substantially have the same electric potential; the second connection ports 342 corresponding in position on the second wiring boards 34a, 34b, 34c, 34d substantially have the same electric potential; and the second connection ports 342 substantially have the same electric potential as the electric potential of the corresponding first connection ports 332. As such, other components (such as the driving device 6 of the control system) may be electrically connected to the stators 3A, 3B, 3C, 3D through the first wiring board 33a and the second wiring board 34d, without the need to be electrically connected to the first wiring boards 33b/33c/33d or the second wiring boards 34a, 34b, 34c, thus reducing wiring complexity and saving time.

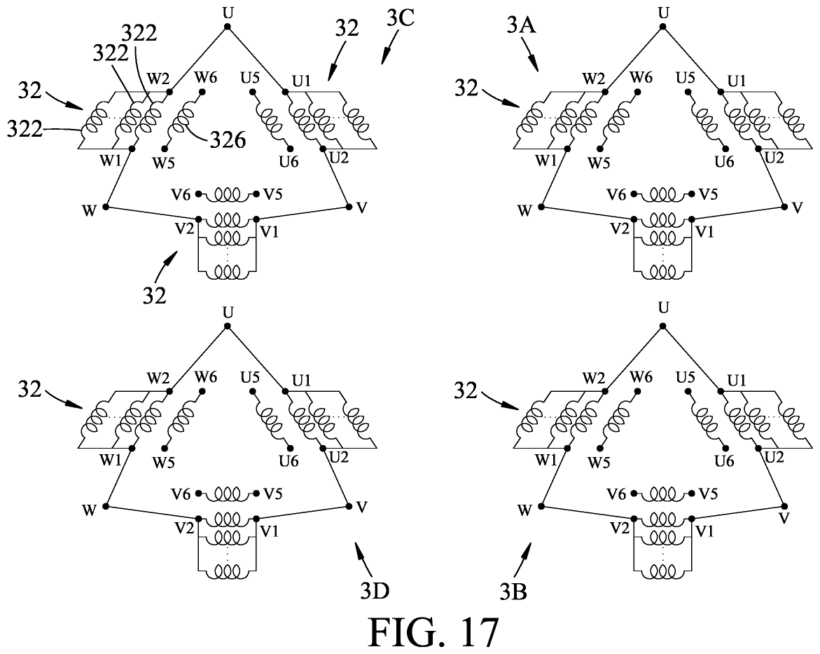

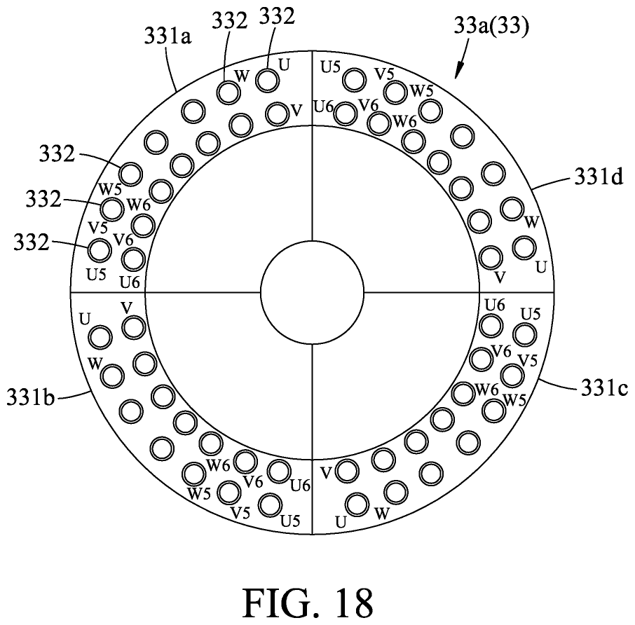

FIGS. 11, 17, and 18 illustrate the stators 3 arranged in the A configuration, and the first wiring boards 33 corresponding to such stators 3. It should be noted that, similar to the stators 3 arranged in the Y configuration, the first wiring boards 33a, 33b, 33c, 33d are identical to each other, and the second wiring boards 34a, 34b, 34c, 34d have mirror correspondence with the first wiring boards 33a, 33b, 33c, 33d so it will not be described in further detail.

In the fourth embodiment, the stators 3 are sleeved on the rotor 2 along the axial direction (L). If any one of the stators 3 needs maintenance, it may be quickly disassembled from the rotor 2, thereby reducing maintenance costs. Furthermore, based on user needs, other stators of different specifications may quickly replace the stators 3, so that the motor 1 may achieve different values of power output.

In addition, the coil modules 32 of each of the stators 3 are distributed along the axial direction (L) to disperse heat generated from operation of the stators 3. Compared to a case where all of the coil modules 32 are disposed in only one of the stators 3, the motor 1 of the disclosure has a better heat dissipation effect and is less likely to cause overheating abnormalities. Furthermore, magnetic field lines generated by the stators 3 will cooperatively affect the rotor 2, resulting in better power generation efficiency.

The detection device 7, the control device 82, and the switch 81 cooperatively operate such that the motor 1 may operate based on the terrain where the electric vehicle, which is provided with the motor 1, is located. When the motor 1 is not required to provide a large amount of power output, the second winding sets 326 of each of the stators 3 may be switched by the switch 81 to provide the generated electricity to the battery set 51 to be used by the motor 1 so as to conserve energy; when the motor 1 is required to provide a large amount of power output, the second winding sets 326 of each of the stators 3 may be switched by the switch 81 to be disconnected from the battery set 51, so that the second winding sets 326 of each of the stators 3 may be used for driving the motor 1. As such, compared to the conventional motor, the battery life of the battery set 51 of the disclosure may be increased by receiving the generated electricity, and thus a size of the battery set 51 of the disclosure may be reduced compared to the conventional motor with the same required battery life for its battery set.

By having the first connection ports 332 correspond respectively with the second connection ports 342 in position, any adjacent two of the stators 3 may be quickly dissembled to be connected to another one of the stators 3, thus improving the efficiency of disassembling and saving time and cost.

The disclosure allows other components of the control system to be electrically connected to the stators 3A, 3B, 3C, 3D through the first wiring board 33a and the second wiring board 34d, without the need to be electrically connected to the first wiring boards 33b, 33c, 33d or the second wiring boards 34a, 34b, 34c, thus reducing wiring complexity and saving time.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A motor comprising:
a rotor; and
a stator including a stator core, and at least one coil module that is wound on said stator core, each of said at least one coil module including a plurality of first winding sets that are wound on said stator core, each of said first winding sets including a first end and a second end,
wherein, for each of said at least one coil module, said first ends respectively of said first winding sets are electrically connected to each other, and said second ends respectively of said first winding sets are electrically connected to each other, such that said first winding sets are connected in parallel.

2. The motor as claimed in claim 1, wherein said at least one coil module of said stator includes three coil modules that correspond to three phases respectively.

3. The motor as claimed in claim 2, wherein said first winding sets correspond to an identical power output.

4. The motor as claimed in claim 2, wherein each of said coil modules further includes:
a first coil group including said first winding sets; and
a second coil group including a plurality of second winding sets that are wound on said stator core, each of said second winding sets includes a third end and a fourth end, wherein said third ends respectively of said second winding sets are electrically connected to each other, and said fourth end respectively of said second winding sets are electrically connected to each other, such that said second winding sets are connected in parallel.

5. The motor as claimed in claim 4, wherein said second winding sets correspond to an identical power output.

6. The motor as claimed in claim 4, wherein, for each of said coil modules, a number of said first winding sets of said first coil group is greater than a number of said second winding sets of said second coil group.

7. The motor as claimed in claim 4, wherein a value of power output corresponding to said first winding sets is smaller than a value of power output corresponding to said second winding sets.

8. The motor as claimed in claim 4, wherein a number of turns of each of said first winding sets is smaller than a number of turns of each of said second winding sets.

9. A motor comprising:
a rotor extending in an axial direction; and
a plurality of stators each being sleeved on said rotor, each of said stators including
a stator core,
a plurality of coil modules that are wound on said stator core, each of said coil modules including a plurality of first winding sets that are wound on said stator core, each of said first winding sets including a first end and a second end, and
a first wiring board and a second wiring board that are disposed on said stator core and that are opposite to each other along the axial direction,
wherein, for each of said coil modules, said first ends respectively of said first winding sets are electrically connected to each other, and said second ends respectively of said first winding sets are electrically connected to each other, such that said first winding sets are connected in parallel,
wherein said first wiring board includes a plurality of first connection ports, said second wiring board includes a plurality of second connection ports electrically connected to said first connection ports respectively, and said coil modules are electrically connected to said first connection ports.

10. The motor as claimed in claim 9, wherein for each of said stators, said first connection ports correspond respectively to said second connection ports in position, such that when said first wiring board of one of said stators engages with said second wiring board of another one of said stators that is adjacent to said one of said stators, said first connection ports of said one of said stators contact and electrically connect to said second connection ports of said another one of said stators respectively.

11. The motor as claimed in claim 10, wherein, for each of said stators:
said first wiring board includes a plurality of first wiring areas, and said first connection ports are arranged in a plurality of first port groups that are disposed respectively in said first wiring areas; and
said second wiring board includes a plurality of second wiring areas that correspond respectively to said first wiring areas in position, and said second connection ports are arranged in a plurality of second port groups that are disposed respectively in said second wiring areas, and said second connection ports of one of said second port groups correspond respectively to said first connection ports of a corresponding one of said first port groups in position.

12. The motor as claimed in claim 11, wherein for each of said stators, said coil modules are electrically connected to said first connection ports of one of said first port groups that is disposed in one of said first wiring areas.

13. The motor as claimed in claim 12, wherein each of said stators is a three-phase stator, and each of said coil modules has one of a group of U, V, W terminals and a group of U, V, W, N terminals electrically connected to said first connection ports that are disposed in said one of said first wiring areas.

14. The motor as claimed in claim 11, wherein, for every adjacent two of said stators,
in one of said adjacent two of said stators, said coil modules are electrically connected to said first connection ports of one of said first port groups that is disposed in a first one of said first wiring areas,
in another one of said adjacent two of said stators, said coil modules are electrically connected to said first connection ports of one of said first port groups that is disposed in a second one of said first wiring areas, and
said first one of said first wiring areas of said one of said adjacent two of said stators is misaligned with said second one of said first wiring areas of said another one of said adjacent two of said stators along the axial direction.

15. The motor as claimed in claim 10, wherein each of said stators includes a plurality of conductive components disposed on said first wiring board and said second wiring board, a set of said conductive components that are disposed on said first wiring board protrude from said first wiring board to form said first connection ports, and another set of said conducting components that are disposed on said second wiring board sink into said second wiring board to form said second connection ports.

16. A control system for an electric vehicle, comprising:
a power supply device configured to provide electric power;
a driving device electrically connected to said power supply device;
said motor as claimed in claim 1, said stator electrically connected to said driving device and said power supply device;
a detection device electrically connected to said power supply device, and configured to make detection on one of terrain where the electric vehicle is located and operation of said motor, and to output a detection signal related to a result of the detection; and
a control device electrically connected to said power supply device, said driving device and said detection device, and configured to output a control signal to said driving device based on the detection signal,
wherein said driving device is configured to output a driving signal to said motor based on the control signal received from said control device, and said motor is configured to operate based on the driving signal from said driving device and to provide electricity to said power supply device.

17. The control system as claimed in claim 16, further comprising a switch electrically connected to said power supply device, said stator and said control device, and configured to be controlled by said control device to switch between a connecting state where said switch electrically connects said stator to said power supply device and a disconnecting state where said switch disconnects said stator from said power supply device.

18. The control system as claimed in claim 17, wherein when the detection signal indicates that an inclination of the terrain is greater than 10 degrees, said control device controls said switch to switch to the disconnecting state.

19. The control system as claimed in claim 17, wherein when the detection signal indicates one of a first condition where an inclination of the terrain is smaller than 10 degrees and a second condition where a rotation speed of said motor corresponds to a speed of the electric vehicle greater than 50 km/h, said control device controls said power switch device to switch to the connecting state.
